(19) United States
(12) Patent Application Publication
(10) Pub. No.: US 2003/0202666 A1
(43) Pub. Date: Oct. 30, 2003

(54) Hand-held acoustic assistant

(76) Inventor: Bing Ren Ching, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/128,278

(22) Filed: Apr. 24, 2002

(51) Int. Cl. H04R 29/00

(52) U.S. Cl. 381/58; 381/56; 381/124

(57) ABSTRACT

A hand-held acoustic audio assistant receives exterior sound signals, and calculates and analyzes these signals to generate corresponding sound pressure/electrical signal levels and frequency spectrum. The results are stored in a memory unit or a memory card. The analyzed sound samples can be further directly heard via earphones. An acoustic audio specialist equipped with the hand-held acoustic audio assistant can thereby perform analysis for surrounding sounds in real time.

### BACKGROUND OF THE INVENTION

1. Field of the Invention

The present invention relates to a hand-held acoustic assistant, and more particularly, to a hand-held electronic device integrates several often-used tools fox an acoustic audio specialist in it.

2. Description of Prior Arts

Hand-held electronic devices such as personal digital assistants (PDA) or pocket personal computers become increasingly popular. Typical hand-held electronic devices usually can provide several functions like data storage, name card management, schedule arrangement, event-to-be tracking, electronic dictionary, stock live reporting, and other information transmission services. Provided with such a hand-held electronic device, the user can manage the information in real time and have a better control of available resources. Moreover, as the dimension of hand-held electronic devices is reduced, they can be also conveniently used in combination with other peripheral component devices such as touch stylus, keyboard, or camera, thereby diversifying their utilization.

However, the acoustic audio specialist is not yet equipped with such kind of hand-held device which integrates useful utility tools therein for the same concept as described above.

### SUMMARY OF THE INVENTION

It is therefore a principal object of the present invention to provide a hand-held acoustic audio assistant that can integrate the functions of the sound pressure and electrical signal level measurement and calculation, frequency spectrum analysis, and other calculations and analysis operations.

To accomplish the above and other objectives, a hand-held acoustic audio assistant includes a control unit, a display unit, an input/output (I/O) interface unit, an expansion unit, a local sound-source input unit, a memory card access unit, a memory unit, and a transmission interface unit. The control unit controls the operations of the hand-held acoustic audio assistant. The display unit is coupled with the control unit to display signals outputted from the control unit. The I/O interface unit which is possibly integrated within a CPU/DSP chip, is coupled with the control unit and the display unit to converts signals between the I/O interface unit and the control unit. The expansion unit is coupled with the I/O interface unit. The local sound-source input unit is coupled with the I/O interface unit to receive an exterior sound signal which can be analyzed into pressure level and frequency spectrum by the control unit. The memory card access unit is coupled with the I/O interface unit to read and write a sound sample of the exterior sound signal to a memory card. The memory unit is coupled with the control unit to store a plurality of sets data of sound pressure level and frequency spectrum of the sound signal and a plurality of patching records of an audio system. The transmission interface unit is coupled with the I/O interface unit to transfer the patching records stored in the memory unit to the external acoustic audio system, or receive a plurality of patching records from the external acoustic audio system to the memory

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a general block diagram of a hand-held acoustic audio assistant according to an embodiment of the invention; and

FIG. 2 is a block diagram of an expansion unit according to an embodiment of the invention.

### DETAILED DESCRIPTION OF THE PREFERRED EMBODIMENTS

Wherever possible in the following description, like reference numerals will refer to like elements and parts unless otherwise illustrated.

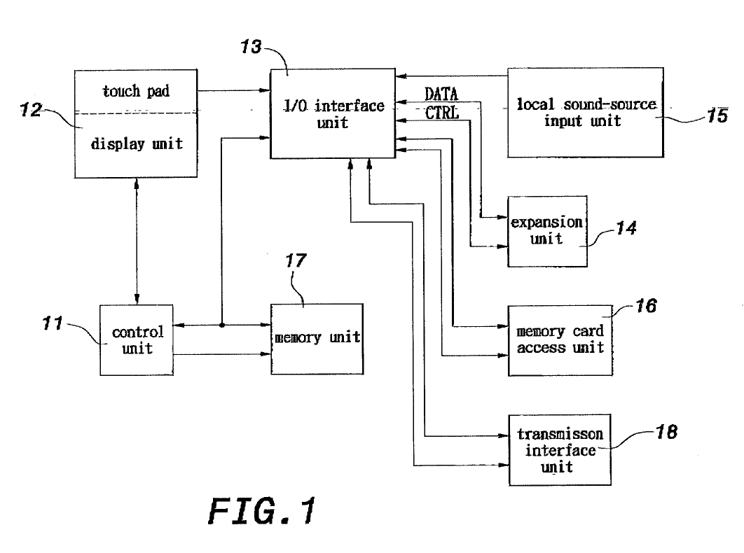

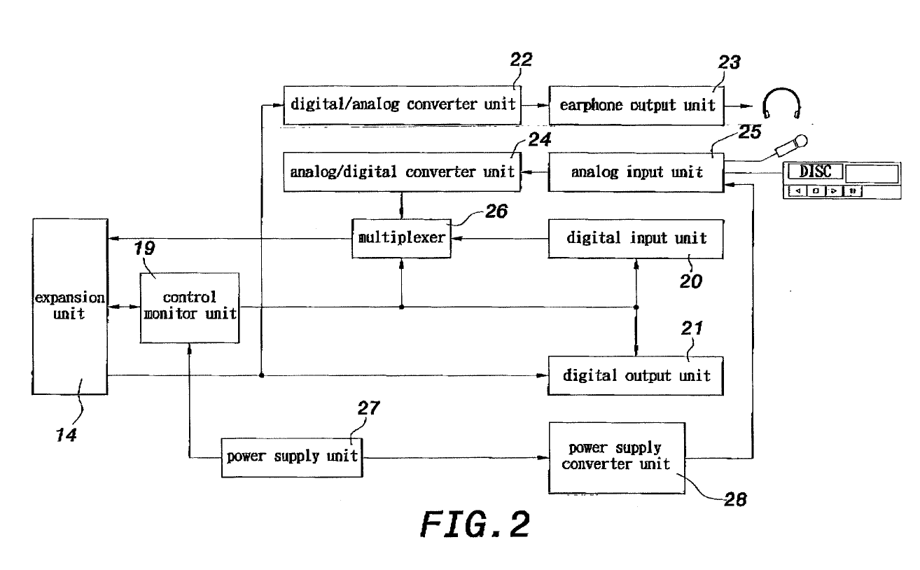

Referring to FIG. 1 and FIG. 2, two block diagrams illustrate a hand-held acoustic audio assistant and an input/output (I/O) interface unit according to the present invention. The hand-held acoustic audio assistant includes a control unit 11, a display unit 12, an input/output (I/O) interface unit 13, an expansion unit 14, a local sound-source input unit 15, a memory card access unit 16, and a memory unit 17.

The control unit 11 controls the operations of the hand-held acoustic audio assistant. The control unit 11 includes a central processor unit and a digital signal processor for performing a plurality of calculations including sound pressure level calculations and providing sound frequency analysis displayed in a graphical manner.

The display unit 12 is coupled with the control unit 11 to display signals outputted from the control unit 11. The display unit 12 is provided with a touch panel that enables a user to rapidly input data and, thereby, to conveniently store various patching records of the acoustic audio system.

The I/O interface unit 13 is coupled with the control unit 11 and the display unit 12 to perform data exchange.

The local sound-source input unit 15 is coupled with the I/O interface unit 13 to receive exterior sound or electrical signals. Moreover, these signals will be analyzed into sound pressure and electrical signal levels and frequency spectrum via the control unit 11, and the local sound-source input unit 15 further performs a simultaneous analysis of the difference between two sound paths.

The memory card access unit 16 is coupled with the I/O interface unit 13 to read out or write in sound samples of the sound signal into a memory card. The user can thereby store these sound samples by means of the memory card.

The memory unit 17 is coupled with the control unit 11 to store the sound pressure/electrical signal levels and frequency spectra of a plurality of sound signal samples. The memory unit 17 further stores a plurality of patching records of the audio system inputted, via the touch panel of the display unit 12.

A transmission interface unit 18 is further coupled with the I/O interface unit 13 to transmit the patching records from the memory unit 17 to an external audio system. The transmission interface unit 18 also receives a plurality of patching records from the external acoustic audio system to the memory unit 17. The transmission interface unit 18 specifically transmits data via, for example, infrared signals.

The expansion unit 14 is coupled with the I/O interface unit 13. The expansion unit 14 further includes at least one control monitor unit 19, a digital input unit 20, a digital output unit 21, a digital/analog converter unit 22, an earphone output unit 23, an analog/digital converter unit 24, an analog input unit 25, and a multiplexer 26. The control monitor unit 19 is coupled with the expansion unit 14 to test connection of the balanced audio cable. The digital output unit 21 is coupled with the control monitor unit 19 to output a test signal from the control unit 11 to one end of the balanced audio cable. The digital input unit 20 is coupled with the control monitor unit 19 to receive the test signal from the other end of the balanced audio cable.

The digital/analog converter unit 22 is to convert a digital signal to an analog signal. The earphone output unit 23 is coupled with the digital/analog converter unit 22, so that the analyzed sound samples can be thereby directly heard via the earphones. The analog input unit 25 receives either external sound source inputs (not shown) from microphones or various output signals from an acoustic audio system connected to the hand-held acoustic audio assistant. The analog/digital converter unit 24 is coupled with the analog input unit 25 to convert an analog signal from the external sound source into a digital signal that can be processed and analyzed by the control unit 11. The multiplexer 26 is coupled with the analog/digital converter unit 24 and the digital input unit 20. The control monitor unit 19 hence controls the multiplexer 26 to switch the analog/digital converter 24 or the digital input unit 20 to the expansion unit 14. A power supply unit 27 is further connected to a power supply converter unit 28, therefore, the power supply voltage can be converted into +48V for phantom power microphones.

The hand-held acoustic audio assistant as described has the following advantages of:

1) Conversion and analysis of sound pressure/electrical signal levels, thereafter achieving such conversion analyses in real time, and therefore, managing suitable adjustment for settings of the operation level based on these analyses;

.2) Detecting difference between two input sound signals, no matter they come from microphone-line, microphone-microphone, or line-line.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A hand-held acoustic audio assistant comprising:
a control unit for controlling operations of the hand-held acoustic audio assistant;
a display unit coupled with the control unit for displaying signals outputted from the control unit;
an input/output (I/O) interface unit coupled with the control unit and the display unit for converting the signals between the input/output interface unit and the control unit;
an expansion unit coupled with the I/O interface unit; a local sound-source input unit coupled with the I/O interface unit for receiving exterior sound signals whose sound pressure level and frequency spectrum are calculated by the control unit;
a memory card access unit coupled with the I/O interface unit for reading and writing a sound sample of the exterior sound signal to a memory card;
a memory unit coupled with the control unit for storing a plurality of sound pressure/electrical signal levels and frequency spectra from the exterior sound signals and a plurality of first patching records; and
a transmission interface unit coupled with the I/O interface unit for transferring the patching records from the memory unit to an external receiving acoustic audio system, or receiving a plurality of patching records from the external acoustic audio system to the memory unit.

2. The hand-held acoustic audio assistant of claim 1, wherein the control unit comprises a central processor unit (CPU) and a digital signal processor (DSP) for performing a plurality of calculations including sound pressure level calculations and providing a sound frequency analysis displayed in a graphical manner.

3. The hand-held acoustic audio assistant of claim 1, wherein the display unit further comprises a touch panel.

4. The hand-held acoustic audio assistant of claim 1, wherein the expansion unit further comprises:
a control monitor unit coupled with the I/O interface unit for testing a balanced audio cable;
a digital output unit coupled with the control monitor unit for delivering a test signal to one end of the balanced audio cable;
a digital input unit coupled with the control monitor unit for receiving the test signal from the other end of the balanced audio cable;
an earphone output unit for receiving sound samples from the I/O interface unit; and
an analog input unit for receiving an external sound source input.

5. The hand-held acoustic audio assistant of claim 4, wherein the earphone output unit further comprises a digital/analog converter unit for converting a digital signal from the I/O interface unit into an analog signal.

6. The hand-held acoustic assistant of claim 4, wherein the analog input unit further comprises an analog/digital converter unit for converting an analog signal from the external sound source input into a digital signal that is further transferred to the I/O interface unit.

7. The hand-held acoustic assistant of claim 6, wherein analog/digital converter unit further comprises a multiplexer for switching the analog/digital converter or the digital input unit to the expansion unit.
